(19) United States
(12) Patent Application Publication
(10) Pub. No.: US 2024/0047715 A1
(43) Pub. Date: Feb. 8, 2024

(54) AN ENERGY STORAGE DEVICE

(71) Applicant: Lavo Hydrogen Storage Technology Pty Ltd, New South Wales (AU)

(72) Inventors: Paul Damon BROCKBANK, New South Wales (AU); Kondo-Francois AGUEY-ZINSOU, New South Wales (AU); Poojan Jitendra MODI, New South Wales (AU)

(21) Appl. No.: 18/037,983

(22) PCT Filed: Nov. 19, 2021
(86) PCT No.: PCT/AU2021/051381

§ 371 Date: May 19, 2023

(30) Foreign Application Priority Data
Nov. 20, 2020 (AU) 2020904293

(51) Int. Cl. H01M 8/04082; C22C 14/00; C22C 22/00; H01M 16/00; H01M 8/0656; C25B 1/04; C25B 9/70; C25B 9/19; C25B 15/021; H02J 15/00

(52) U.S. Cl. CPC H01M 8/04216; C22C 14/00; C22C 22/00; H01M 16/006; H01M 8/0656; C25B 1/04; C25B 9/70; C25B 9/19; C25B 15/021; H02J 15/008; C22C 2202/04; H01M 2250/10

(57) ABSTRACT

An integrated energy storage device, including: an electrolyser for generating hydrogen through electrolysis of water; a metal hydride store fluidly coupled to the electrolyser, for receiving and converting the hydrogen from a gaseous form to solid state metal hydrides and back to hydrogen when required, and one or more fuel cells coupled to the metal hydride store, for generating electricity from hydrogen generated from the metal hydride store.

### TECHNICAL FIELD

The present disclosure relates to an energy storage device. More particularly, the present disclosure relates to a fully integrated hydrogen energy storage device, for plug and play energy storage and generation.

### BACKGROUND

Households and businesses are constantly looking for alternative ways to maximise their energy use while minimizing their energy cost. In recent years, with the higher penetration of renewable energy usage, there is a strong demand for high density energy storage devices which are powered by renewable energy sources. Existing batteries which are designed to be powered by renewable energy sources do not have sufficient energy density to meet the current need for remote, residential and small business applications. In addition, those batteries tend to have a large foot print, and are heavy, costly and unsafe owing to potential thermal runaway.

There is a need for an alternative energy storage device. There is a need for an energy storage device which achieves a desirable level of efficiency, system integration, simplicity, which also satisfies the health and safety requirements imposed by various government and commercial regulations.

### SUMMARY

In a first aspect, the present disclosure relates to an integrated energy storage device, including:

an electrolyser for generating hydrogen through electrolysis of water;

a metal hydride store fluidly coupled to the electrolyser, for receiving and converting the hydrogen from a gaseous form to solid state metal hydrides and back to hydrogen when required, and one or more fuel cells coupled to the metal hydride store, for generating electricity from hydrogen generated from the metal hydride store.

In one embodiment, the device includes one or more auxiliary energy storage units.

In one embodiment, at least one of the one of more auxiliary energy storage units is a battery.

In one embodiment, the battery is chargeable by at least one of: an external power supply, or an electrolyser of the device.

In one embodiment, the electrolyser is a stackable anion exchange membrane (AEM) electrolyser.

In another embodiment, the electrolyser is an alkaline based proton exchange membrane electrolyser.

Preferably, the electrolyser produces hydrogen at a pressure of 0-35 bar.

In one embodiment, the electrolyser comprises a plurality of electrolytic cells, which are connected in series in a bipolar design.

In one embodiment, the device is fluidly coupled to a water source, for receiving and supplying water to the electrolyser for generating hydrogen.

In one embodiment, the device includes a water storage unit, which supplies water to the electrolyser.

In one embodiment, the device further includes a water purification unit for purifying water to a purity level which is equivalent to a conductivity of less than 20 μS/cm, at 25°C., before the water is supplied to the electrolyser.

In one embodiment, the metal hydride store includes one or more storage vessels for storing the metal hydrides.

In a preferred embodiment, each metal hydride store includes a twin pair of hydrogen storage vessels.

In one embodiment, the one or more storage vessels are removable from the device and replaceable with new storage vessels if required.

In one embodiment, the device allows more storage vessels to be incorporated into the device to achieve a higher energy storage capacity.

In one embodiment, the metal hydride store uses hydrogen storage alloys to convert hydrogen into metal hydrides.

In one embodiment, the metal hydride store is configured to operate at ambient temperatures, for example −20 to 60°C.

In one embodiment, the metal hydride store uses TiMn- and TiCrMn-based hydrogen storage alloys to convert the hydrogen into metal hydrides.

Alternatively, in another embodiment, the metal hydride store uses room temperature metal hydride families, for example but not limited to, AB, AB2, A2B, AB5 based hydrogen storage alloys to convert the hydrogen into metal hydrides.

In one embodiment, the TiMn- and TiCrMn-based hydrogen storage alloys comprise ferrovanadium (VFe) and optionally one or more additional modifier elements.

In a preferred embodiment, the hydrogen storage alloy has a formula Tiₓ,Zr_{y},Mn_{z}Crᵤ(VFe),M_{w}, wherein

M is selected from one or more of V, Fe, Cu, Co, Mo, Al, La, Ni, Ce and Ho;
x is 0.6-1.1;
y is 0-0.4;
z is 0.9-1.6;
u is 0-1;
v is 0.01-0.6;
w is 0-0.4.

In one or more embodiments the alloy has a hydrogen storage capacity of at least 1.5 wt % H₂, or at least 1.6 wt % H₂, or at least 1.7 wt % H₂, or at least 1.8 wt % H₂, or at least 1.9 wt % H₂, or at least 2 wt % H₂, or least 2.1 wt % H₂, or least 2.2 wt % H₂, or least 2.3 wt % H₂, or least 2.4 wt % H₂, or least 2.5 wt % H₂, or at least 2.6 wt % H₂, or at least 2.7 wt. % H₂, or at least 2.8 wt. % H₂, or at least 2.9 wt. % H₂, or least 3 wt % H₂, or least 3.25 wt % H₂, or least 3.5 wt % H₂, or least 3.75 wt % H₂, or at least 4 wt. % H₂ at 30 bar.

In one or more embodiments the alloy has a hydrogen storage capacity of at least 4.5 wt % H₂, or least 5 wt % H₂, or least 6 wt % H₂ at 100 bar.

In one or more embodiments the alloy is adapted to desorb at least 65%, or at least 75%, at least 80%, or at least 85%, or at least 90%, or at least 95% of the stored hydrogen at 30 bar.

In one or more embodiments the alloy is capable of a rate of uptake and release of hydrogen of at least about 0.5 g H₂/min, or at least about 0.75 g H₂/min, or at least about 1.0 g H₂/min, or at least about 1.25 g H₂/min, or at least about 1.4 g H₂/min.

In preferred embodiments the hydrogen storage alloy has a C14 Laves phase.

In one embodiment, the device includes temperature regulating units for maintaining components of the device within a predefined temperature range.

In one embodiment, the temperature regulating units include one or more of the following: blower fans, radiator, heating components, air circulation fans, and so on.

In one embodiment, the device includes one or more ventilation units for promoting air flow within and/or surrounding the device.

In one embodiment, the device includes an enclosure for housing components of the device.

In preferred embodiments, various components of the device are electrically and/or fluidly coupled to each other within the enclosure.

In one embodiment, the device is a plug and play type energy storage and supply device.

In one embodiment, the device includes one or more coupling means for electrically connecting to a local electrical load to supply electricity to the electrical load.

In one embodiment, the device includes one or more coupling means for electrically connecting to an external power supply. In one embodiment, the external power supply is provided by a renewable energy source, such as solar. Preferably, the external power supply is generated by an array of solar photovoltaic (PV) panels.

In one embodiment, the external power supply draws power from a power grid.

In one embodiment, the one or more coupling means comprise electrical connection cables, ports, or sockets which are accessible from the enclosure.

Throughout this specification, unless the context clearly requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term ‘consisting essentially of’ means that the listed features are the essential features, but other non-essential or non-functional features may be present that do not materially alter the way the invention works.

Throughout this specification, the term ‘consisting of’ means consisting only of.

Any discussion of documents, acts, materials, devices, articles or the like which has been included in the present specification is solely for the purpose of providing a context for the present technology. It is not to be taken as an admission that any or all of these matters form part of the prior art base or were common general knowledge in the field relevant to the present technology as it existed before the priority date of each claim of this specification.

Unless the context requires otherwise or specifically stated to the contrary, integers, steps, or elements of the technology recited herein as singular integers, steps or elements clearly encompass both singular and plural forms of the recited integers, steps or elements.

In the context of the present specification the terms ‘a’ and ‘an’ are used to refer to one or more than one (i.e., at least one) of the grammatical object of the article. By way of example, reference to ‘an element’ or ‘an integer’ means one element or integer, or more than one element or integer.

Where a range of values or integers is given in this specification, the recited range is intended to include any single value or integer within that range, including the values or integers demarcating the range endpoints. Accordingly, and by way of illustration, in this specification a reference to the range ‘from 1 to 6’ includes 1, 2, 3, 4, 5 and 6, and any value in between, e.g., 2.1, 3.4, 4.6, 5.3 and so on. Similarly, a reference to the range from ‘0.1 to 0.6’ includes 0.1, 0.2, 0.3, 0.4, 0.5 and 0.6 and any value in between, e.g., 0.15, 0.22, 0.38, 0.47, 0.59, and so on.

In the context of the present specification the term ‘about’ means that reference to a number or value is not to be taken as an absolute number or value, but includes margins of variation above or below the number or value in line with what a skilled person would understand according to the art, including within typical margins of error or instrument limitation. In other words, use of the term ‘about’ is to be understood to refer to an approximation that a person or skilled in the art would consider to be equivalent to a recited number or value in the context of achieving the same function or result.

Those skilled in the art will appreciate that the technology described herein is susceptible to variations and modifications other than those specifically described. It is to be understood that the technology includes all such variations and modifications. For the avoidance of doubt, the technology also includes all of the steps, features, and compounds referred to or indicated in this specification, individually or collectively, and any and all combinations of any two or more of said steps, features and compounds. That is, various discrete or preferred embodiments of the invention have been disclosed, however it should be understood that this disclosure implicitly encompasses all scientifically feasible combinations of embodiments disclosed herein, even if those combinations have not been expressly disclosed.

In order that the present technology may be more clearly understood, preferred embodiments will be described with reference to the following figures and examples.

### BRIEF DESCRIPTION OF THE DRAWINGS

FIG. 1 shows a physical layout of various components of an energy storage device, in accordance with one embodiment of the present disclosure.

FIG. 2 shows an embodiment of a metal hydride store when viewed from different angles.

FIG. 3 shows how various components of the device may be fluidly coupled to each other to efficiently transport water, hydrogen and air through the device.

FIG. 4 shows an exemplary layout of a control system and how it may interface with the components of the device.

FIG. 5a shows four exemplary states of operation of the energy storage device.

FIG. 5b illustrates different modes of operation of the energy storage device when it is incorporated into an overall power supply system.

FIGS. 6a, 6b and 6c show a perspective view, a front view and a back view of an exemplary energy storage device respectively.

### DETAILED DESCRIPTION OF EMBODIMENTS

The present disclosure relates to a fully integrated energy storage device. The device can be readily integrated into an existing power supply system, to provide electricity to a local load on demand. The device offers a ‘plug and play type’ solution, with main functional components of the device fully or substantially encapsulated in a device enclosure. From a functional perspective, the main components of the energy storage device may be broadly divided into the following categories : hydrogen generation components, hydrogen conversion and storage components, and electrical power generation components. The main functional components are electrically and/or fluidly coupled to each other within the device enclosure, operating as a fully integrated and automated energy storage and supply device.

In some embodiments, the device also includes other components which assist with, or control, the operation of the main functional components. Such components may include, but are not limited to, one or more auxiliary energy storage units, temperature and/or pressure regulating units, ventilation units, control systems, and so on.

In a most preferred embodiment, the device includes: an electrolyser, as a hydrogen generation component for producing hydrogen in a gaseous form through electrolysis of water; a metal hydride based hydrogen store, typically in the form of a tank or vessel, for storing the generated hydrogen in a solid state form as metal hydrides, and one or more fuel cells as the electrical power generation components which generates electrical power by converting chemical energy of a fuel, for example hydrogen released from the metal hydride vessel, into electricity to supply to an electrical load.

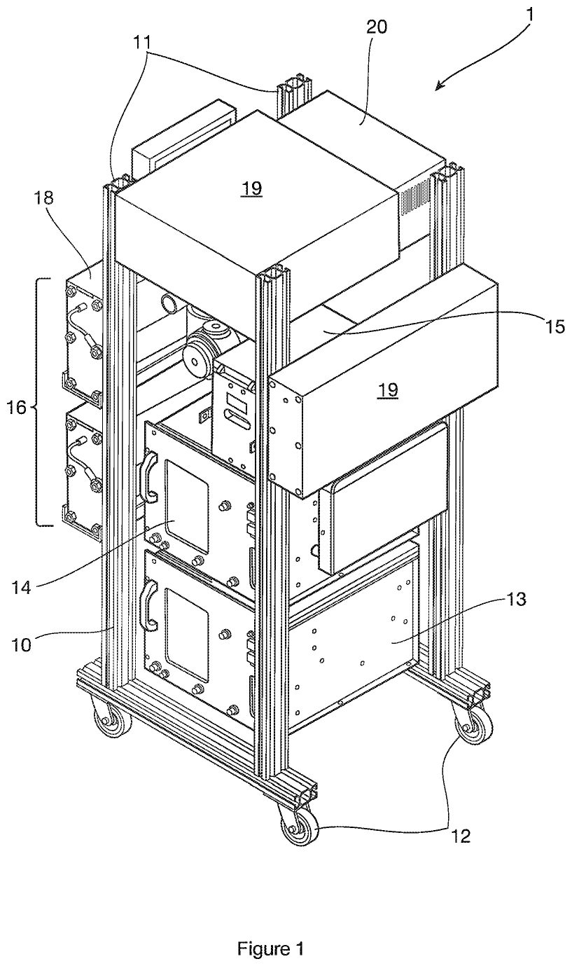

Various components of the device and methods of operating the device will be described below with reference to FIGS. 1 to 6c.

### Hydrogen Gas Generation

In one embodiment, the energy storage device includes an electrolyser for generating hydrogen. A hydrogen electrolyser is a device which uses electrical energy to convert water into its composite parts, hydrogen and oxygen, through electrolysis. During electrolysis, oxygen can be directly released into the air, and/or stored within the device and reused by a fuel cell to increase its efficiency when generating power, whereas hydrogen is used by the energy storage device to generate electricity.

In one embodiment, the energy storage device includes a stackable anion exchange membrane (AEM) electrolyser. The electrolyser comprises a plurality of electrolytic cells, which are connected in series in a bipolar design. Each electrolytic cell comprises a membrane electrode assembly (MEA) made from a polymeric AEM, an anode, and a cathode. The anode side of the electrolytic cell is referred to as the anodic half cell, which is filled with diluted alkaline (KOH) electrolyte solution. The cathode side of the electrolytic cell is referred to as the cathodic half cell, which generally has no liquid and produces hydrogen from water permeating the polymeric membrane form the anodic half cell through electrolysis. Oxygen is generated from the anodic side and transported out from the plurality of electrolytic cells through the circulating electrolyte solution.

The electrolyser is configured to generate hydrogen in a gaseous form under pressure, around 35 bar (1 bar equals 100 kPa). Preferably, the hydrogen gas is sufficiently dry and can reach a purity of greater than 99.9%. In one embodiment, an auxiliary dryer module may be coupled to, or included in the electrolyser, to further reduce the moisture content in the hydrogen gas and improve hydrogen purity to greater than 99.999%. The hydrogen gas is then ready to be supplied to a metal hydride store, which converts the hydrogen from its gaseous form into a solid state form, for example by bonding it to hydrogen storage alloys.

In one embodiment, the energy storage device includes a water inlet, for receiving a supply of water from a nearby water source. The water source may come from a tap connected to a fixed water supply system, rainwater, or processed water such as distilled or purified water. In one embodiment, the water inlet is fluidly coupled to the electrolyser through a conduit, for supplying water thereto. In another embodiment, the device includes a water storage unit within itself, which can be filled with water and the electrolyser draws water directly from the water storage unit. In yet another embodiment, a water purification unit is also included in the device, to purify water to a purification level which is equivalent to a conductivity of less than 20 μS/cm, at 25°C., before the water is supplied to the electrolyser. As hydrogen is generated by the electrolyser, the water storage unit is replenished to ensure a continuous and stable supply of water to the electrolyser.

Typically, the electrolyser has an ambient operating temperature of 5 to 45° C. and a pressure range of 0 to 35 bar. In order to maintain the temperature of the electrolyser within a predefined range, for example to avoid freezing, the device includes various temperature regulating units, one of which is a heating unit, for example electrically heated mantles, to preheat the electrolyser when it is in standby mode. In this mode the electrolyser is kept at a temperature for allowing quick start-up and avoiding water freeze. To ensure safety, the device also includes various ventilation units for promoting air flow within and/or surrounding the device. For example, the device may include a fan for removing any remaining hydrogen and oxygen, before entering in standby mode.

In a preferred form, the energy required for the electrolyser to perform electrolysis is provided by a renewable energy source as well, for example from an array of solar panels. Alternatively, a different energy source may be used to power the electrolyser, for example from electricity supplied by a power grid, or from an auxiliary energy storage unit of the device itself, which will be explained further below.

### Hydrogen Conversion and Storage

Another main functional component of the energy storage device is its hydrogen conversion and storage unit. Hydrogen is a very reactive gas and has the highest density of energy per unit weight of any chemical fuel, but it has a very low volumetric energy density. Advantageously, the present energy storage device includes a metal hydride store, which converts hydrogen from its gaseous form into a solid state form, which greatly reduces the space required to store the hydrogen generated by the electrolyser, thereby increasing its volumetric energy density.

In one embodiment, the metal hydride store comprises one or more vessels, each of which is configured to convert and store hydrogen gas as metal hydrides. The metal hydride store is a passive hydrogen conversion and release unit, which does not require dedicated control circuitry for controlling its operation. The metal hydride store self-regulates to absorb and release hydrogen. In this regard, certain metals and alloys are known for the reversible storage of hydrogen. Solid-phase storage of hydrogen in a metal or alloy system works by absorbing hydrogen through the formation of a metal hydride under a specific temperature/pressure or electrochemical conditions, and releasing hydrogen by changing these conditions. When bound to metal hydrides in the form of alkali-, alkaline earth-, transition- and rare-earth metals, hydrogen can be safely stored. Metal hydrides offer the advantage of high-density hydrogen- storage through the insertion of hydrogen atoms into the metal crystal lattice. However, the composition of metal hydride alloys greatly influences how well the alloy can bond, store and release hydrogen.

In one embodiment, the hydrogen storage alloy has a formula Tiₓ,Zr_{y},Mn_{z}Crᵤ(VFe),M_{w}, wherein

M is selected from one or more of V, Fe, Cu, Co, Mo, Al, La, Ni, Ce and Ho;
x is 0.6-1.1;
y is 0-0.4;
z is 0.9-1.6;
u is 0-1;
v is 0.01-0.6;
w is 0-0.4.

Integers x, y, z, u, v and w refer to mole number in the alloy formula. Integer w represents the total proportion (mole number) of modifier element M, which may be comprised of a single element or a combination of two or more elements. When M comprises a combination of two or more elements, each element may be present in any amount or ratio such that the total does not exceed the value w. In a preferred embodiment, w is 0.01-0.4.

This specific hydrogen storage alloy and methods of making such hydrogen storage alloy have been described in details in Australian provisional patent application No 2019902796 titled ‘Hydrogen Storage Alloys’ filed 5 Aug. 2019, International PCT application No PCT/AU2020/050804, and International PCT application No PCT/AU2020/050805, the entire contents of which are hereby incorporated by cross reference.

In a preferred embodiment, the metal hydride store has an operating temperature of −10 to 50° C. and a pressure range of 2 to 30 bar. The metal hydride has a storage capacity of 0.53 kWh kg⁻¹ or greater than 1.6 wt % H₂ and volumetric capacity of 3.3 kWh L⁻¹.

To ensure the metal hydride store stays within its operating conditions, the energy storage device includes temperature regulating components for the metal hydride store as well, including but not limited to a heat exchanger, electrical heater, Peltier elements, and similar thereof.

In an embodiment, the one or more vessels of the metal hydride store are configured to be replaced by new vessels, and thus the energy storage capacity of the metal hydride store may be modified based on its application, and the usage cycle life of the metal hydride store can be prolonged as new vessels are incorporated into the device.

### Electrical Power Generation

A fuel cell is a device which converts hydrogen from its solid state and air into electrical power and heat. To supply electrical power to an electrical load, the energy storage device includes one or more of such fuel cells, for generating electricity from the reaction between hydrogen and oxygen from the air. A by-product of this reaction process is water, which may be released as liquid and/or vapour.

In a preferred form, the fuel cell has an optimal operating temperature of 60 to 65° C. under a hydrogen pressure of 0.15 to 0.3 bar. The fuel cell can be defrosted naturally at a sufficiently high ambient temperature. Alternatively, external defrost and heat-up with Glycol is also possible. Control of temperature and defrosting can also be done by an electrical heating mantel, recirculating fluid, and the like. To ensure safety, the fuel cell is fully vented from remaining hydrogen and air before entering in standby mode.

### An auxiliary Energy Storage Unit

In one embodiment, the energy storage device includes one or more auxiliary energy storage units, at least one of the units may be a battery. The main function of the auxiliary energy storage unit is to supplement the electrical power output of the energy storage device during a high demand period, and to enable a base load power to run the overall system while in standby mode. It may be discharged to start-up the one or more fuel cells, and supply power until the fuel cells start generating stable electricity from the metal hydrides. The battery can be of any type, for example, lead acid, Ni-Cd, and the like.

Instead of providing an auxiliary energy storage unit within the device, it is envisaged that the functionalities of the auxiliary energy unit may also be achieved by an AC power grid, and a grid inverter which generates DC power from the AC power grid. In yet another embodiment, the auxiliary energy storage unit may include a supercapacitor.

In a preferred embodiment, the battery is always kept charged to at least 50% of its full capacity, to ensure there is sufficient power output to the local load, when the energy storage device is in its standby mode and for rapid start of the various functional components of the energy storage device. This also ensures the life cycle of the energy storage device is able to achieve up to 10,000 discharge cycles.

### Data Display & Human Machine Interface (HMI)

In one embodiment, the energy storage device includes an associated data display and human machine interface (HMI) accessible through a web platform or a downloadable application to provide full monitoring and automation including self-regulation of the energy storage device as well as control of the operation of the device.

In one form, the HMI is configured to display one or more of the following information:
Time of day;
Solar PV output;
Electrolyser output;
Storage percentage in the metal hydride store;
Fuel cell output;
Temperature of all major functional components;
Power required by the local load;
Inverter status;
DC/DC Converter status;
Exported power; and
Cycle ount for the energy storage device .

In addition or alternative to the data display, the energy storage device may also include a status light which indicates the status of the device visually.

### Physical Configuration of the Device

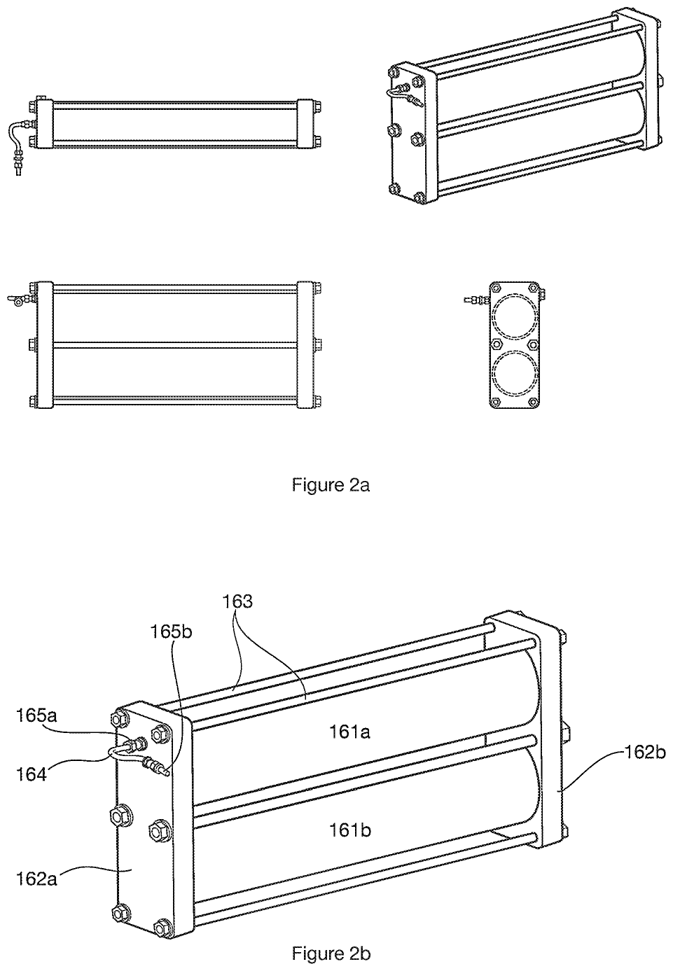

The internal configuration of the energy storage device will be described below with reference to FIGS. 1, 2a and 2b.

FIG. 1 illustrates an exemplary configuration of the energy storage device 1 and its internal layout. For ease of illustration, only some the functional components are shown in the FIG. 1.

In this configuration, the energy storage device 1 is of a physical dimension of approximately 1.7 metres in height, 0.5 meters in width and depth. Various components of the device 1 are securely supported by a frame structure 10, comprising a plurality of vertically and horizontally extending rails 11, typically made from a metal material. A plurality of castor wheels 12 are provided at the ground contacting point of the frame structure 10, enabling the device 1 to be wheeled and relocated to a suitable location more easily.

One of the design considerations of the device 1 is that heavier components should preferably be positioned near a bottom side of the device 1, and lighter components should generally be positioned above the heavier components. For example, in the embodiment shown in FIG. 1, a water storage unit 13 is situated at a bottom end of the device 1, for storing water that is required by the electrolyser 14. The electrolyser 14 is located in close proximity to the water storage unit 13, for example it may be located directly above the water storage unit 13, and is fluidly coupled to the water storage unit 13 for drawing water therefrom.

A fuel cell 15 is positioned above the electrolyser 14, and next to a humidifier unit 18 which assists with humidifying the dry air coming from the outside of the device 1. As the fuel cell 15 releases hydrogen periodically for respiration purposes, the device 1 may include an air blower (not shown) for diverting the hydrogen away from electronic components 19, the auxiliary energy storage unit (not shown) and a DC-DC converter 20. The fuel cell 15 needs high air intake when it generates electricity, so its location and its associated blower should be close to the air inlet which it takes air from.

Two metal hydride stores 16 are positioned on a side wall of the device 1, in a stacked configuration. More details of the metal hydride stores 16 will be described with reference to FIGS. 2a and 2b.

FIG. 2a shows a perspective view, a side plan view, an end view, and a bottom plan view of a metal hydride store 16. FIG. 2b shows an enlarged side perspective view of the same metal hydride store 16. Depending on the configuration and the level of expected electrical power output, the energy storage device 1 may be configured to include any number of metal hydride stores 16. In a typical residential application, the device is configured to include 1 to 4 of such metal hydride stores 16. Each metal hydride store 16 includes two storage vessels 161a, 161b, which are generally of a cylindrical body shape, and are arranged in a substantially parallel configuration. The storage vessels 161a, 161b are supported by two spaced apart and parallel fixing plates 162a and 162b at each end of their cylindrical body. A number of rods 163 also extend between the two fixing plates 162a, 162b, which securely maintain the relative position of the two fixing plates 162a, 162b.

A conduit 164 extends between a first connector 165a which is provided on a side wall of fixing plate 162a, and a second connector 165b which is arranged to connect to the electrolyser 14. The conduit 164 and the connectors 165a, 165b are used to transport the hydrogen gas between the metal hydride store 16 and the electrolyser 14.

In one embodiment, each vessel 161a, 161b is configured to accommodate 1 kg of metal hydrides, which is able to provide 20 kWh of nominal storage. If the energy storage device 1 comprises four of such vessels, then a total of 80kWh nominal storage can be offered by the device 1. Comparing to existing energy storage devices, for example Tesla's Powerwall and LG Solar batteries, the present energy storage device offers a much higher nominal storage capacity. In use, the device is able to output a maximum output power of 6 kW, which is again significantly higher than existing energy storage devices.

As the vessels 161a, 161b are adapted to receive compressed hydrogen gas from the electrolyser, which is classified as a very harmful gas, they must be designed to withstand high pressure and have a high operating temperature tolerance. Preferably, the vessels 161a, 161b are adapted to withstand an internal pressure of 50 bar and a maximum operating temperature of 100° C. The cylindrical body of the vessels 161a and 161b are made from a metal material, for example, aluminium. Preferably, the fixing plates 162a and 162b are also made from metal materials such as aluminium.

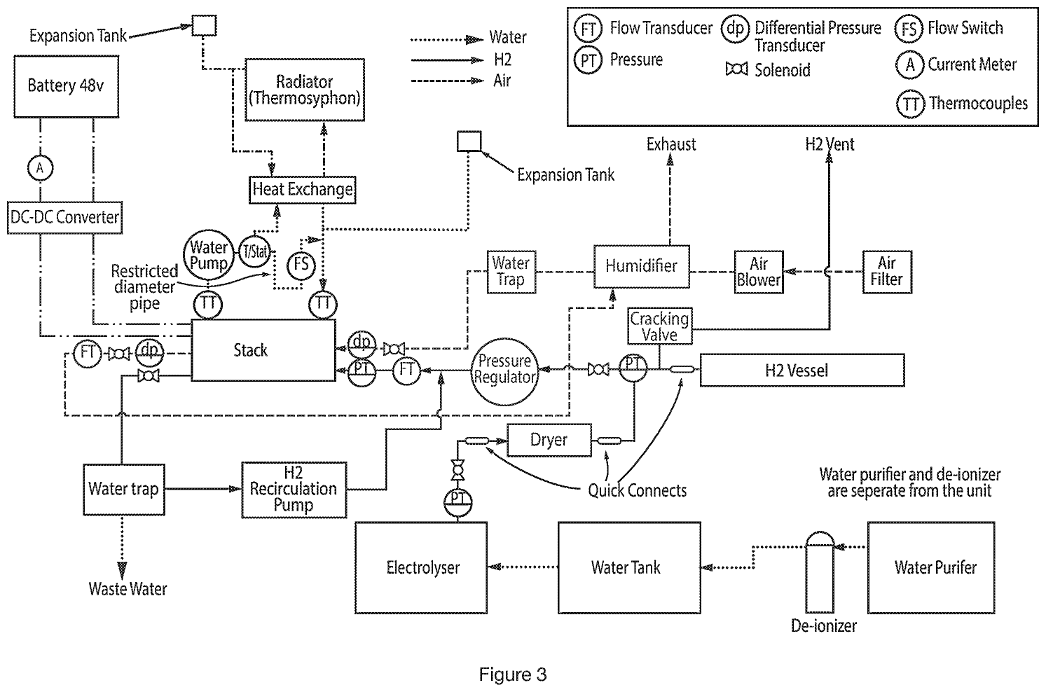

FIG. 3 is an illustration of how the various components of the device 1 may be integrated to efficiently transport water, hydrogen, and air through the device. The arrows indicate the direction of fluid travel from one component to another.

Modes of operation

The operation of the energy storage device 1 is monitored and automated by a control system.

In one embodiment, the control system comprises one or more programmable logic controllers (PLC), which are programmed in accordance with a set of specific rules of operation. The one or more PLCs are adapted to interface with various components of the device 1, through suitable protocols.

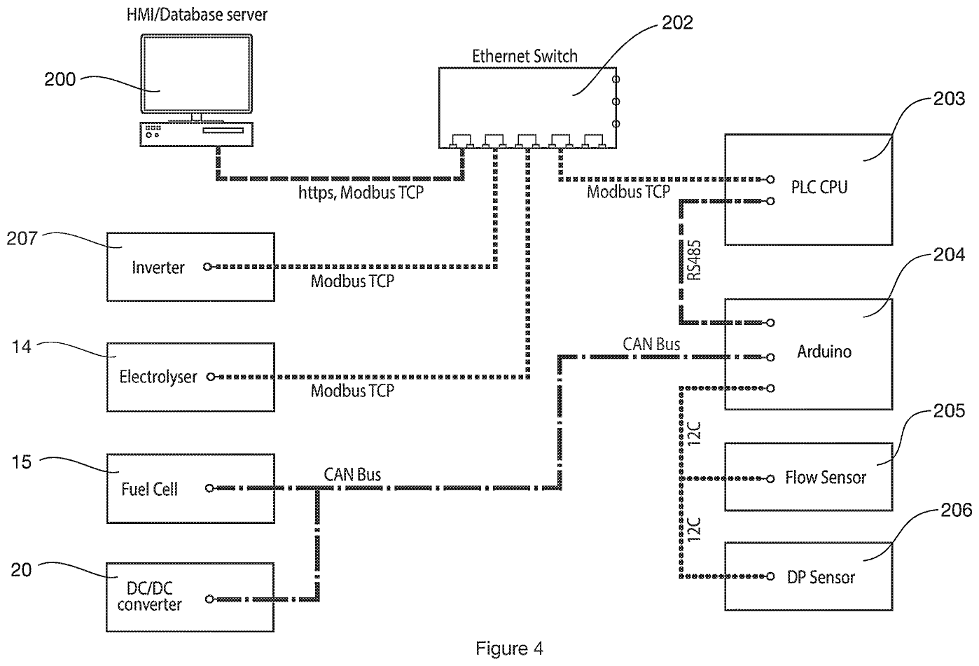

FIG. 4 illustrates a logical diagram of the control system and its interfacing with components of the device. In this embodiment, the control system includes a PLC 203, a microcontroller 204, and a database server 200, which are configured to exchange data representative of the device operating conditions via a network accessible from an ethernet switch 203. The HMI has been described above, and is mainly used to display relevant information to an operator. In this embodiment, the HMI is directly accessible from the database server 200 which may be used to store historic data and any other system information. The control system monitors and controls the operation of the inverter 207, the electrolyser 14, the fuel cell 15, the DC-DC converter 20, and various sensors such as a flow sensor 205 and a pressure sensor 206.

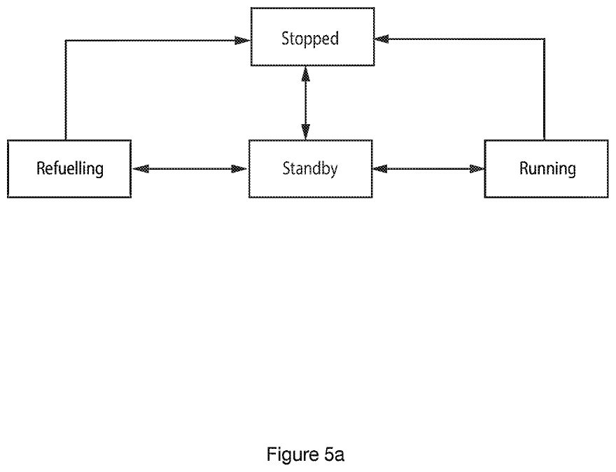

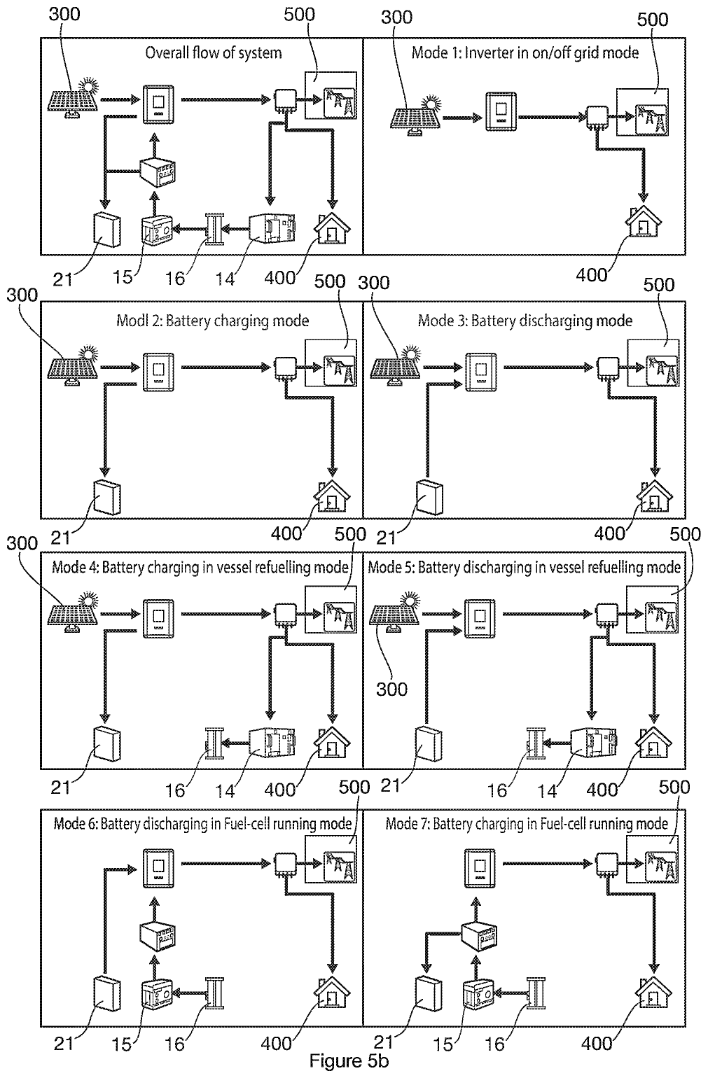

As mentioned previously, in some configurations, the energy storage device 1 is incorporated into a residential or commercial power supply system, to supply electricity to a local load. The configuration and operation of the device 1 are determined by various factors such as the level of local electricity demand, the state of charge of the auxiliary energy storage unit, the amount of metal hydrides already stored in the device, the level of renewal energy input to the energy storage device to power its functional units, current temperatures of the various functional components described above, and similar thereof. Broadly speaking, the control system is programmed to monitor and control the operation of the device 1 in the four exemplary, non-limiting states of operation as shown in FIG. 5a, including: a stopped state, a standby state, a refuelling state, and a running state.

In the stopped state, all of the components of the device 1 are turned off. The device may require a physical reset (e.g. circuit breaker reset) before it can be turned on again. Alternatively, the control system may attempt a number of safe restarts, each after a pause for a few minutes.

In the standby state, the device 1 is switched on, however, its components are not in an operational status to generate electricity or to generate hydrogen.

In the refuelling state, the fuel cell will not be operating, however the electrolyser will be running to generate hydrogen and the metal hydride store will be operating to convert hydrogen gas into metal hydrides.

In the running state, the fuel cell will be operating to generate electricity to supply to a local power load, whereas the electrolyser temporarily stops producing hydrogen.

In order to transition between the refuelling state and the running state, the device must first go into the standby state first. This allows the device to ventilate any residual hydrogen out of the device or diverts it away from the electronic components which are housed within the enclosure.

Whist FIG. 5a illustrates the four basic states of operation of the device 1, it should be appreciated that when the device 1 is integrated into a power supply system in a practical implementation, the operation of the device 1 and the overall power supply system could be far more complex than what is shown in FIG. 5a.

FIG. 5b is a diagram which shows energy flow within another power supply system, which includes 7 different modes of device operation. The arrows in FIG. 5b generally indicate the direction of energy flow from one component to another. For ease of illustration, each of Mode 1 to Mode 7 only includes components which are relevant to that Mode. The components which are not operating or not particularly relevant to the Mode are not illustrated in FIG. 5b.

### 1) Stand-by Mode

When the power output from the solar panels 300 is low, and/or when the metal hydride store is full, the device 1 is allowed to enter into a stand-by mode, in which at least one, and preferably both of the electrolyser and fuel-cell are not running, or at least not operating at its full operational capacity. In this mode, the auxiliary energy storage unit (e.g. a battery 21), could be in a state of charging, discharging or in stand-by mode as well. This mode aligns with Mode 1, 2 and 3 in FIG. 5b (inverter in on/off grid mode, battery charging mode, battery discharging mode).

In Mode 1, if the output of the solar panels 300 is lower than a predetermined level, electricity is directly supplied to a local load by power grid 500.

In Mode 2, if the output of the solar panels 300 has reached a desirable level, excessive solar energy is used to recharge the battery 21.

In Mode 3, as the battery 21 reaches a specific charging state, for example, if more than 50% of the battery is charged, it is allowed to start discharging and supplying electricity to the local electrical load 400.

### 2) Hydrogen Generation Mode

When the local power demand is very low and solar generation is high, the energy storage device 1 enters into a hydrogen generation mode, in which the electrolyser 14 operates at its fully capacity to generate hydrogen, which is then converted into solid state metal hydrides by the metal hydride store 16. By doing so, excess solar energy is stored in the form of solid state hydrogen. Some of the excess solar energy may also be used to recharge the battery 21, as the arrow indicates in Mode 4. In certain situations, when the output from the solar panels 300 experiences temporary fluctuations, the battery 21 operates as a buffer and provides steady power to the electrolyser 14 and the local load 400, as indicated by the direction of energy flow in Mode 5.

In both Mode 4 and 5, the electrolyser 14 generates hydrogen which is converted into solid state metal hydrides by the metal hydride store 16.

3) Fuel cell generation mode

When the local power demand exceeds the amount of power generated by the solar panels 300, by a pre-determined amount, for example at night or in a high load scenario, the one or more fuel cells 15 start to operate to generate electricity to supply to the local load 400. To supplement the energy storage device 1, the power grid 500 may also be relied on to ensure sufficient electricity is supplied to the local load 400, particularly when the power generation by the fuel cells 14 is insufficient. This scenario aligns with Mode 6 and 7 in FIGS. 5b .

In Mode 6, the battery 21 is above its minimum state of charge threshold and is able to discharge with or without the fuel-cell 14 to meet the load demand.

In Mode 7, excess energy from the fuel-cells 14 may be directed to charge the battery 21, so that it is always maintained above the minimum state of charge threshold.

### 4) Hybrid Mode

In a hybrid mode, hydrogen generation and fuel-cell generation take place simultaneously, meaning the fuel-cell and electrolyser are both operating. This mode provides benefit for maintenance purposes to expedite the testing of hydrogen leaks in the system or monitoring/regulating the entire system in a single test, however, it is generally not recommended as it could potentially reduce the efficiency of the power generation and supply.

As mentioned previously, the main functional components of the device 1 are electrically and/or fluidly coupled to each other within the device enclosure, operating as a fully integrated and automated energy storage and supply device. However, the main components of the energy storage device, which include the hydrogen generation components, the hydrogen conversion and storage components, and the electrical power generation components, are also configured to operate independently without the involvement of the other components. This configuration allows a modular design where replacing a component of the device 1 does not impede the rest of the components. In some embodiments, the components of the device are each mounted on its own rack which allows an easy ‘click and connect’ type of installation and connection to electrical circuits and fluid paths within the device 1.

The modular configuration mentioned above allows for replacement or upgrading of the individual components of the device without affecting the rest of the system. There are a number of scenarios which may require components of the device 1 to be replaced, or temporarily decommissioned.

For example, gaseous hydrogen may be supplied to the device externally from hydrogen pipelines, instead of from the electrolyser. If this is a desired mode of operation, the electrolyser may be removed from the device, and the rest of the device would still function as intended.

As another example, instead of using the metal hydride store to convert and store hydrogen as metal hydrides, gaseous hydrogen may alternatively be collected and stored in its gaseous form, while allowing the rest components of the units to still function as intended.

In a further example, instead of using a fuel cell to generate electricity and supply to a local load, a hydrogen combustion engine can be connected to the device to produce electricity as intended.

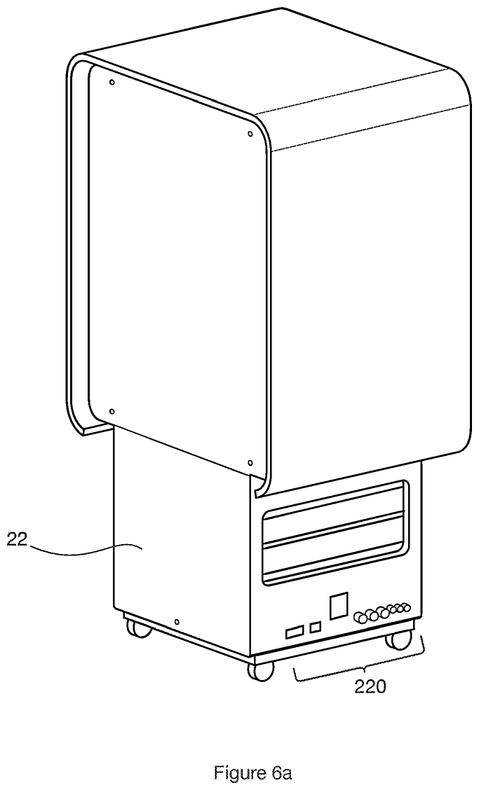

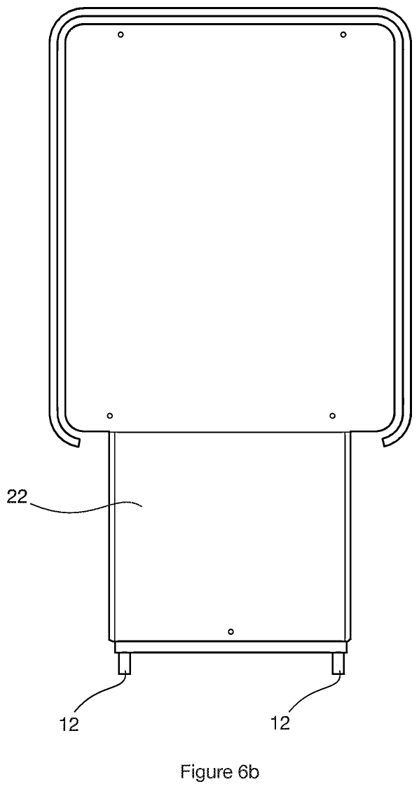

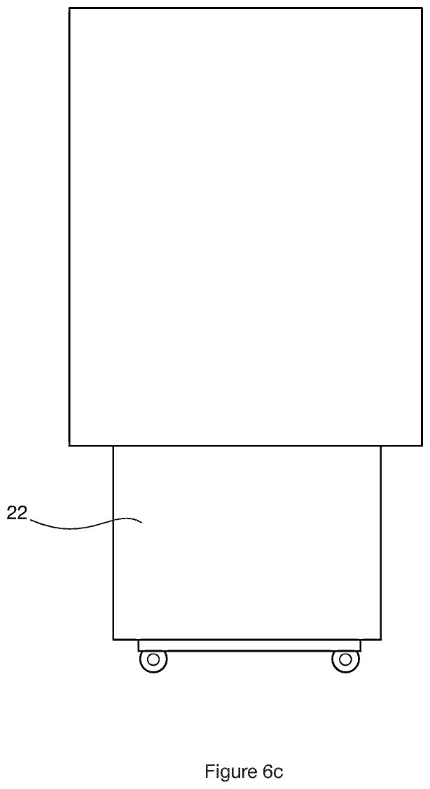

FIGS. 6a, 6b, 6c show a perspective view, a front view, and a back view of an example of the energy storage device 1 respectively. The components of the device 1 are housed within an enclosure 22, and supported by a number of castor wheels 12 at the bottom of the enclosure 22. A number of coupling means, such as sockets and ports 220 are provided and directly accessible from the enclosure 22. The sockets and ports 220 may include at least one or more of the following:
DC power input and output socket, which allows the device 1 to be integrated into an existing power system;
Atmosphere air intake, which allows the electrolyser and the fuel cell to receive an air intake from the surrounding atmosphere;
Water inlet, which allows connection to tap water to feed water to the electrolyser, or to the water storage unit, or to the water purification system, which then supplies purified water to the electrolyser;
AC power socket, which receives an AC power supply to power the electrolyser and/or the water storage unit;
Ethernet port, which is connected directly to the network switch available inside the device 1 which is in signal communication with components of the device 1 inside the enclosure 22;
Drain water port, for discharging waste water from the device 1;
Maintenance drain port, which is useful to drain the water from the electrolyser and the water storage unit completely in order to perform maintenance tasks on the device when required;
Oxygen vent for venting out the oxygen produced by the electrolyser safely into the atmosphere and away from the hydrogen line;
Hydrogen vent for venting out the hydrogen from the unit. Preferably, hydrogen is allowed to escape from the device 1 from the top of the enclosure 22, as hydrogen is lighter than air.

### Advantages of the Present Invention

The present disclosure describes an energy storage device which offers many advantages over existing energy storage devices such as lithium-ion batteries, and existing hydrogen based energy supply systems.

The present invention is a fully integrated, plug and play solution to renewable energy generation and storage. Previously, distributed hydrogen energy systems have been built, in which components of the system are physically located at distributed locations. With the present invention, a compact, plug and play type energy storage solution is achieved. The fully integrated energy storage device requires a much smaller footprint compared to previous distributed hydrogen energy storage systems. In a residential environment, the device is an integrated unit which is able to be fitted in a garage or a corner of a property. In commercial settings, the device is still small and compact, and allows easy installation and integration with existing power supply systems.

The invention also offers great flexibility, as it can be integrated into an existing power supply system, or used as an independent energy storage device, off grid. Components of the device can also be removed and replaced easily.

Due to its compactness, some components of the device 1 can be thermally coupled, achieving a more efficient heat dissipation and reuse. For example, the heat generated by fuel cells, could be reused by the metal hydride store and/or the electrolyser, enabling a more efficient, balanced heat usage and dissipation by the device.

It is generally known that hydrogen is an appealing proposition as a renewable energy source. However, hydrogen is a very reactive and high combustible gas, and has a very low volumetric energy density. It has been somewhat challenging to build an energy storage device which offers a high volumetric energy density, and which is also safe and reliable for it to be accepted by end users. The present invention offers a high density energy storage device both in terms of volumetric and gravimetric measures, leading to small energy storage devices of 4.1 kWh L⁻¹, and 0.7 kWh kg⁻¹ in comparison to the 0.7 kWh L⁻¹ volumetric and 0.3 kWh kg −¹ gravimetric energy density of conventional Li-ion batteries. As hydrogen is stored in its solid state form, the device also benefits from its sophisticated safety and emergency measures that can respond to low ppm levels of hydrogen leak, electrical faults, or high temperature fluctuations for example in case of fire. It is a much more appealing solution for residential and industrial applications due to its significantly improved safety features.

Some existing batteries suffer from a memory effect, for example nickel-cadmium and nickel metal hydride rechargeable batteries, which means after repeated charging and discharging cycles, their maximum energy capacity is gradually lost. In worst cases, the batteries could lose its storage capacity permanently. The present invention does not suffer from such memory effect, and it can be fully charged, discharged or partially charged/discharged without any adverse effects.

When coupled with a solar power system, the device offers a truly renewable energy generation and storage solution. Some existing lithium-ion battery devices are able to be coupled to a solar power system to be recharged as well. However, the manufacturing of lithium-ion batteries and disposal of such batteries often create other serious environmental concerns. In the present invention, hydrogen is generated from water, and the metal hydrides are fully recyclable too, making it a truly ‘renewable’ and sustainable energy storage device.

1-35. (canceled)

36. An integrated energy storage device, including:
an electrolyser for generating hydrogen through electrolysis of water;
a metal hydride store fluidly coupled to the electrolyser, for receiving and converting the hydrogen from a gaseous form to solid state metal hydrides and back to hydrogen when required;
one or more fuel cells coupled to the metal hydride store, for generating electricity from hydrogen generated from the metal hydride store;
an enclosure for housing the electrolyser, the metal hydride store, and the one or more fuel cells therein, and
one or more coupling means for electrically connecting to a local electrical load to supply electricity to the electrical load, wherein the one or more coupling means are accessible from the enclosure.

37. The integrated energy storage device according to claim 36, wherein the device includes one or more auxiliary energy storage units.

38. The integrated energy storage device according to claim 37, wherein at least one of the auxiliary energy storage unit is a battery, which is chargeable by at least one of: an external power supply, or an the electrolyser of the device.

39. The integrated energy storage device according to claim 36, wherein the electrolyser is a stackable anion exchange membrane (AEM) electrolyser, or an alkaline based proton exchange membrane.

40. The integrated energy storage device according to claim 36, wherein the electrolyser comprises a plurality of electrolytic cells, which are connected in series in a bipolar design.

41. The integrated energy storage device according to claim 36, wherein the device is fluidly coupled to a water source, for receiving and supplying water to the electrolyser for generating hydrogen.

42. The integrated energy storage device according to claim 36, wherein the metal hydride store includes one or more storage vessels for storing the metal hydrides.

43. The integrated energy storage device according to claim 36, wherein the metal hydride store includes a twin pair of hydrogen storage vessels.

44. The integrated energy storage device according to claim 42, wherein the one or more storage vessels are removable from the device and replaceable with new storage vessels if required.

45. The integrated energy storage device according to claim 36, wherein the metal hydride store uses hydrogen storage alloys to convert hydrogen into metal hydrides.

46. The integrated energy storage device according to claim 36, wherein the metal hydride store uses Tiₓ,Zr_{y},Mn_{z}Crᵤ(VFe),M_{w}, wherein
M is selected from one or more of V, Fe, Cu, Co, Mo, Al, La, Ni, Ce and Ho;
x is 0.6-1.1;
y is 0-0.4;
z is 0.9-1.6;
u is 0-1;
v is 0.01-0.6;
w is 0-0.4.

47. The integrated energy storage device according to claim 45, wherein the alloy has a hydrogen storage capacity of at least 1.5 wt % H₂, or at least 1.6 wt % H₂, or at least 1.7 wt % H₂, or at least 1.8 wt % H₂, or at least 1.9 wt % H₂, or at least 2 wt % H₂, or least 2.1 wt % H₂, or least 2.2 wt % H₂, or least 2.3 wt % H₂, or least 2.4 wt % H₂, or least 2.5 wt % H₂, or at least 2.6 wt % H₂, or at least 2.7 wt. % H₂, or at least 2.8 wt. % H₂, or at least 2.9 wt. % H₂, or least 3 wt % H₂, or least 3.25 wt % H₂, or least 3.5 wt % H₂, or least 3.75 wt % H₂, or at least 4 wt. % H₂ at 30 bar.

48. The integrated energy storage device according to claim 45, wherein the alloy has a hydrogen storage capacity of at least 4.5 wt % H₂, or least 5 wt % H₂, or least 6 wt % H₂ at 100 bar.

49. The integrated energy storage device according to claim 45, wherein the alloy is adapted to desorb at least 65%, or at least 75%, at least 80%, or at least 85%, or at least 90%, or at least 95% of the stored hydrogen at 30 bar.

50. The integrated energy storage device according to claim 45, wherein the alloy is capable of a rate of uptake and release of hydrogen of at least about 0.5 g H₂/min, or at least about 0.75 g H₂/min, or at least about 1.0 g H₂/min, or at least about 1.25 g H₂/min, or at least about 1.4 g H₂/min.

51. The integrated energy storage device according to claim 45 , wherein the hydrogen storage alloy has a C14 Laves phase.

52. The integrated energy storage device according to claim 36, wherein the metal hydride store uses room temperature metal hydride families, for example but not limited to, AB, AB2, A2B, AB5 based hydrogen storage alloys to convert the hydrogen into metal hydrides.

53. The integrated energy storage device according to claim 36, wherein the device includes one or more ventilation units for promoting air flow within and/or surrounding the device.

54. The integrated energy storage device according to claim 36, wherein components of the device are electrically and/or fluidly coupled to each other within the enclosure.

55. The integrated energy storage device according to claim 36, wherein the device is a plug and play type energy storage and supply device.
